(19) United States
(12) Patent Application Publication
(10) Pub. No.: US 2026/0241651 A1
(43) Pub. Date: Aug. 20, 2026

(54) ANNEALING MODULE OF A DEVICE FOR PRODUCING STRETCHED THERMOPLASTIC TAPES

(71) Applicant: STARLINGER & CO GESELLSCHAFT M.B.H., Wien (AT)

(72) Inventors: Franz SCHNEIDER, Bad Fischau-Brunn (AT); René WEISS, Furth an der Triesting (AT)

(21) Appl. No.: 18/992,646

(22) PCT Filed: Jun. 28, 2023
(86) PCT No.: PCT/EP2023/067596

§ 371 Date: Jan. 9, 2025

(30) Foreign Application Priority Data
Jul. 11, 2022 (EP) 22184126.5

(51) Int. Cl. B29C 71/02; B29K 67/00; B29L 7/00; H05B 1/02

(52) U.S. Cl. CPC B29C 71/02; H05B 1/023; B29C 2071/022; B29K 2067/00; B29L 2007/007

(57) ABSTRACT

The annealing module of a device for producing stretched thermoplastic tapes has a housing with an inlet and an outlet for the passage of the plastic tapes to be treated through the inner space of the housing. Within the inner space a plurality of rotationally driven rollers are arranged on axes parallel to each other and are at least partly enclosed by the thermoplastic tapes. The annealing module includes a heating source for heating the inner space uniformly up to a temperature, which is at least 70% of the melting temperature of the plastic tapes to be treated, and for heating the inner space up to a temperature of at most 5% above the melting temperature of the thermoplastic tapes to be treated. The rollers are driven at such a rotational speed that the thermoplastic tapes, as a function of the path through the annealing module, have a dwell time within the annealing module of at most 10 seconds.

### BACKGROUND

The invention relates to an annealing module of a device for producing stretched thermoplastic tapes.

The production of stretched thermoplastic tapes involves melting plastic, usually in the form of granules. The molten plastic material is pressed through an extrusion die to form a film web, which is then cooled, for example in a water bath or by means of a cooled roller and cut lengthwise into tapes in a subsequent processing step. This is usually achieved by moving the film web over a plurality of knives arranged side by side. After cutting, the plastic tapes are stretched to a multiple of their original length in a hot air oven to increase their tensile strength and E modulus, thereby reducing their width to a fraction of their original width. In order to reduce the residual shrinkage during further processing of the tapes, it is necessary to subject them to a fixing process known as annealing.

During annealing, the tapes are heated to a temperature above their glass transition temperature. This is usually achieved by passing the tapes over heated rollers, also known as godets, as described in patent application WO 2019/034488, whereby the plastic tapes in the inner space between the godets are not exposed to the same conditions as at the contact points with the godets and are therefore heated unevenly. Specifically, the tapes are polyamide filaments produced by spinnerets. Polyamide has a glass transition temperature of typically 60-75° C. The shell surfaces of the godets are heated to a surface temperature of 130-190° C. and thus far above the glass transition temperature of polyamide.

An uneven temperature effect on the plastic tapes during annealing can lead to undesirable deformation of the tapes. To prevent this, patent specification US 6472066 discloses a process, in which short cut PET fibres obtained by melt spinning are produced with low residual shrinkage by annealing the fibres by heating them uniformly under pressure with saturated hot water vapour. The saturated water vapour condenses on the fibres. These fibres are then suitable for the production of wet-laid nonwovens. PET has a glass transition temperature of approximately 80° C. The fibres are annealed at a high temperature of at least 165° C. The water vapour supplied thus has a temperature far above the glass transition temperature of PET. In addition, the supplied water vapour escapes from the fibre treatment zone to the environment through two vapour outlets.

Treating stretched plastic tapes with water vapour to fix them (annealing) is unsuitable as this process would require an additional drying step afterwards. This drying step is not feasible in practice because the tapes are wound onto spools at high speed after annealing. The ribbons would therefore have an unacceptably short dwell time in a dryer, or the dryer would have to be of an unrealistically long length. In addition, the use of water vapour is resource intensive and costly.

### BRIEF SUMMARY

It is therefore the object of the present invention to provide an annealing module of a device for producing stretched thermoplastic tapes, which ensures uniform heating of the tapes to a temperature suitable for annealing and the presence of constant, controllable conditions within a short period of time, and which at the same time functions in a resource-and cost-saving manner.

This task is solved by providing an annealing module having the features of claim 1. Advantageous embodiments of the invention are set forth in the dependent claims as well as in the description and the drawings.

The annealing module according to the invention of a device for producing stretched thermoplastic tapes has a housing, which defines an inner space, wherein the housing has an inlet and an outlet for the passage of the plastic tapes to be treated through the inner space.

Within the inner space, a plurality of rotationally driven rollers are arranged on axes parallel to each other and are configured to be at least partially enclosed by the plastic tapes. The annealing module is equipped with heating means which are configured to heat the inner space uniformly up to a temperature of at least 70%, preferably at least 75%, of the melting temperature. The rollers are driven at such a rotational speed that the tapes, as a function of the path through the annealing module, have a dwell time within the annealing module of at the most 10 seconds, preferably at the most 5 seconds, even more preferably at the most 3 seconds.

In a preferred embodiment of the invention the heating means are also configured to uniformly heat the inner space up to a temperature of at most 5% above the melting temperature, more preferably of at most 3% above the melting temperature, most preferably of at most the melting temperature of the plastic tapes to be treated. In this embodiment, during the treatment of the plastic tapes, the inner space is thus kept at a pre-set working temperature within a temperature range with the defined minimum temperature and the defined maximum temperature. A brief passage of the plastic tapes through an atmosphere in the inner space, the temperature of which is above the melting temperature, will not damage the plastic tapes as their dwell time in the inner space of the annealing module is very short.

Document EP 2757125 A1 describes the production of a microporous film based on a propylene resin, wherein the resin is first extruded into a film, which is then stretched in two stages and then treated in an annealing oven. The film is passed through the annealing oven in a zig-zag pattern around guide rollers. The film is heated for a predetermined time and then transported out of the oven and continuously wound onto a lap roller. An example embodiment is explained where the film is annealed for 10 minutes so that its surface temperature is 140° C. No tensile force is applied to the film. The document does not contain any information on how the film is heated in the annealing oven. The very long annealing time would be unsuitable to produce stretched thermoplastic tapes according to the invention, as it would damage the molecular structure of the tapes produced under tension. As mentioned above, it has been shown in accordance with the invention that a very short dwell time of the tapes in the annealing module of a maximum of 10 seconds does not damage the tapes even if the temperature in the inner space of the annealing module is above the melting temperature of the tapes. However, a dwell time of several minutes would also damage the tapes and render them unusable if the temperature in the inner space of the annealing module is 70% of the melting temperature of the tapes. The system of EP 2757125 A1 would also be completely unsuitable to produce stretched plastic tapes simply because of its slow operation. Stretched thermoplastic tapes are produced and annealed at speeds of several hundred metres per minute. This is several orders of magnitude faster than the system of EP 2757125 A1 can achieve.

In order to keep the energy consumption of the annealing module low, provisions can be made for thermally insulating the housing.

In a preferred embodiment of the annealing module according to the invention, the heating means comprise a hot gas stream introduced into the inner space, wherein the hot gas stream is preferably formed by at least one hot gas blower arranged outside the housing, the outlet of which leads into the inner space. In this embodiment, the entire inner space can be quickly heated to the desired temperature and temperature adjustments are quickly noticeable in the entire inner space. The hot gas stream is preferably configured as a recirculating air stream, in that it is supplied to the inner space and extracted as a return stream at another point in the inner space and returned to the inlet of the hot gas blower. This enables a particularly energy-saving operation of the annealing module.

In a further embodiment of the annealing module according to the invention, the heating means comprise heating means arranged in the inner space of the housing, preferably electric or inductive heating elements or heating elements with heating fluid flowing through them.

In a further embodiment of the annealing module, the rollers have heating elements, the heating elements preferably comprising electric or inductive heating elements or heating elements with heating fluid flowing through them. In this embodiment, it is possible to heat the rollers up to a temperature range that corresponds approximately to the temperature prevailing in the inner space of the annealing module, so that the plastic tapes are exposed to as little as possible or no temperature differences at all during annealing. In addition, this embodiment allows the inner space of the annealing module to be heated up more quickly, especially if a hot gas stream is used as the heating means.

Preferably, the rotationally driven rollers are arranged so that the surfaces of their shells are wrapped around by the plastic tapes at a wrap angle of less than 360°, but preferably at least 150°.

In order to simplify the control of the rotational speeds of the rollers, a further embodiment of the annealing module according to the invention provides that at least some of the rotationally driven rollers are combined to form at least two roller groups, wherein the rollers of a respective roller group each have the same circumferential speeds of their shell surfaces, wherein-viewed in the direction of transport of the plastic tapes-each roller group has a lower circumferential speed of the shell surfaces of the rollers than the roller group adjacent to it in the opposite direction to the direction of transport.

Optionally, the annealing module may have at least one rotationally driven cooling roller, which is arranged downwards from the outlet of the housing, as viewed in the direction of transport of the plastic tapes. This cooling roller may be operated at a different circumferential speed of its shell surface than the driven rollers arranged in the housing of the annealing module.

For precise adjustment and execution of the annealing process, it is useful to provide a control module for setting and controlling the rotational speeds of the rollers and at least one further parameter selected from the inner space temperature and/or the heating temperature of the heating means.

The design of the annealing module is simplified if the atmosphere in the inner space is an air atmosphere, and any hot gas introduced into the inner space is hot air. In this case, there is no need for complex designs to strictly separate the process gas from the ambient atmosphere. Furthermore, pressure differential resistant insulation and seals may be omitted if the annealing module is configured so that the pressure in the inner space is essentially the same as in the atmosphere surrounding the annealing module.

In a preferred embodiment, the annealing module is adapted for treating plastic tapes made of a polyester material, PET (polyethylene terephthalate) or a polyolefin, in particular PP (polypropylene), HDPE (high-density polyethylene), LLDPE (linear low-density polyethylene). This means that the annealing module can be operated in the temperature ranges optimised for annealing the aforementioned plastic materials.

### BRIEF DESCRIPTION OF THE DRAWINGS

The invention is now explained in greater detail below with reference to the drawings by means of exemplary embodiments. In the drawings:

FIG. 1 is a perspective view of an embodiment of the annealing module according to the invention with an open inner space;

FIG. 2 is a side view of the annealing module with an open inner space; and

FIG. 3 in a side view the annealing module with a closed inner space.

### DETAILED DESCRIPTION

With reference to the figures, an embodiment of the annealing module 1 according to the invention will now be explained in detail. This annealing module 1 is used to carry out an annealing process on stretched thermoplastic tapes 20.

The stretched thermoplastic tapes 20 are produced by melting plastic, usually in the form of granules. The molten plastic material is pressed through an extrusion die to forma film web, which is cooled by cooled rollers, a water bath, etc., and then cut lengthwise into strips by passing the film web over a plurality of adjacent knives. The strips are stretched to a multiple of their original length in a hot air oven under tensile stress, thereby reducing their width to a fraction of the original width, so called stretched plastic tapes 20, which have a multiple of the tensile strength and E modulus of the originally cut strips. The production of the plastic tapes up to the annealing process is known to the skilled person as prior art and therefore need not be described in detail. When the stretched tapes are reheated after cooling, e.g. by a coating process, residual shrinkage will occur. In order to reduce this undesirable residual shrinkage, it is useful to subject the plastic tapes to a fixing process known as annealing, for which the annealing module 1 is used.

The annealing module 1 is part of a device for producing stretched thermoplastic tapes. The annealing module 1 has a housing 2 that defines an inner space 3. The housing 2 is provided with heat-insulating walls to insulate the inner space 3 from ambient temperatures. The housing 2 has an inlet 4 and an outlet 5 for passing the plastic tapes 20 to be treated through the inner space 3. The inlet 4 and the outlet 5 are configured to be slot-shaped and have an inlet sealing lip 4a and an outlet sealing lip 5a, respectively, in order to keep the clear width of the inlet 4 and of the outlet 5 as small as possible and thus to minimise heat losses in the inner space 3. In the inner space 3 there are arranged six rotationally driven rollers 6, 7, 8, 9, 10, 11, so-called godets, on axes parallel to each another and arranged in such a way that they are at least partially wrapped around by the plastic tapes 20. Preferably, the rotationally driven rollers are arranged in such a way that their shell surfaces are wrapped around by the plastic tapes 20 at a wrap angle of less than 360°, but preferably at least 150°.

In the embodiment depicted, the rollers 6, 7, 8, 9, 10, 11 are not heated, but rather absorb the temperature prevailing in the inner space 3 on their shell surfaces. Alternatively, however, at least some of the rollers 6, 7, 8, 9, 10, 11 can be equipped with electrical or inductive heating elements or heating elements with heating fluid flowing through them or other heating elements.

The first two rotationally driven rollers 6, 7—viewed in the direction of transport T of the plastic tapes 20—are combined to form a first roller group, the rotation of which is controlled in such a way that their shell surfaces each have the same circumferential speed V1. The next two rotationally driven rollers 8, 9, which are arranged downstream of the rollers 6, 7, are combined to form a second roller group, the rotation of which is controlled in such a way that their shell surfaces each have the same circumferential speed V2. The last two rotationally driven rollers 10, 11, which are arranged downstream of the rollers 8, 9, are combined to form a third roller group, the rotation of which is controlled in such a way that their shell surfaces each have the same circumferential speed V3. The circumferential speed V1 of the first roller group 6, 7 is higher than the circumferential speed V2 of the second roller group 8, 9. The circumferential speed V2 of the second roller group 8, 9 is higher than the circumferential speed V3 of the third roller group 10, 11. This will form relaxation zones in the transition areas between the first, second and third roller groups, more precisely between the rotationally driven rollers 7, 8 and 9, 10, in which the plastic tapes 20 may relax.

The rollers 6-11 are driven at such a rotational speed that the tapes 20, as a function of their path through the annealing module 1, have a dwell time in the annealing module 1 of at most 10 seconds, preferably at most 5 seconds, even more preferably at most 3 seconds. The length of the tapes 20 in the annealing module 1, i.e. the length of their path in the annealing module 1, is between 4.35 m and 7.65 m, for example. The tapes 20 may be passed through the annealing module 1 at a travelling speed of, for example, between 150 m/min and 650 m/min, resulting in dwell times of 0.4 s to 3.06 s in the annealing module 1.

The annealing module 1 is equipped with heating means for heating the inner space 3 uniformly to a temperature that is at least 70%, preferably at least 75 %, of the melting temperature of the plastic tapes to be treated. The heating means are furthermore controlled in such a way that they ensure uniform heating of the inner space to a temperature of at most 5% above the melting temperature, preferably at most 3% above the melting temperature, more preferably at most the melting temperature of the plastic tapes 20 to be treated. In the illustrated embodiment of the annealing module 1, the heating means are realised by a hot gas blower 14, which is arranged outside the housing 2 and generates a hot gas stream 15, which is blown into the inner space 3 through the outlet of the hot gas blower 14 communicating with the inner space 3. The temperature of the hot gas stream 15 is measured and the hot gas blower 14 is controlled so that the hot gas stream 15 has an (adjustable) desired working temperature. The hot gas stream 15 is preferably guided through the inner space 3 of the housing 2 as a circulating air stream, in that the hot air stream 15 is blown into the inner space 3 by means of the hot gas blower 14 and a return stream 15a is extracted from the inner space at another point in the inner space 3 and returned to the hot gas blower 14. In this way, the annealing module 1 can be operated in a very energy-saving manner.

In alternative embodiments of the annealing module 1, the heating means may be configured as heating elements arranged within the inner space 3, preferably electric or inductive heating elements, or heating elements with heating fluid flowing through them.

As mentioned above, the annealing module 1 is configured to heat the inner space 3 to a temperature of at least 70%, preferably at least 75%, of the melting temperature of the plastic tapes 20 to be treated. At the same time, the heating means are be operated in such a way as to ensure a uniform heating of the inner space to a temperature that is a maximum of 5% above the melting temperature, preferably a maximum of 3% above the melting temperature, and even more preferably a maximum of the melting temperature of the plastic tapes 20 to be treated.

The annealing module 1 can be specifically configured for the type of plastic of the plastic tapes 20. Preferably, the annealing module 1 may be configured for the treatment of plastic tapes 20 made from a polyester material, particularly PET, or a polyolefin, especially PP, HDPE, or LLDPE.

A characteristic of every single plastic material is its melting temperature. Although the melting temperature may vary slightly depending on the manufacturer and other properties imparted to the plastic, it can be found on the data sheet for the respective plastic material.

Polypropylene (PP) has a typical melting temperature of 160° C. To configure the annealing module 1 for PP, the heating means are set to heat the inner space 3 to at least 112° C., which is 70% of the melting temperature of 160° C., or to maintain the temperature in the inner space 3 at this level, respectively. Preferably, the heating means are set to heat the inner space 3 to at least 120° C. (which is 75% of the melting temperature) or to maintain the temperature at this level, respectively. At the same time, the heating means are set to heat the inner space 3 to a maximum of 168° C. (which is 5% above the melting temperature), preferably a maximum of 164.8° C. (which is 3% above the melting temperature), and even more preferably a maximum of 160° C. (which is the melting temperature), or to maintain the temperature in the inner space 3 at this level, respectively. Thus, for PP, there is established an operating temperature range of between 112° C. and 168° C., or in the most preferred embodiment, an operating temperature range of between 120° C. and 160° C. Within the operating temperature range, a working temperature is chosen that depends, among other things, on further characteristics of the plastic material. The annealing module 1 controls the heating means so that the chosen working temperature in the inner space 3 is maintained quite accurately (i.e., with fluctuations of a maximum of ±2° C.).

Polyethylene terephthalate (PET) has a typical melting temperature of 260° C. To configure the annealing module 1 for PET, the heating means are set to heat the inner space 3 to at least 182° C., which is 70% of the melting temperature of 260° C., or to maintain the temperature in the inner space 3 at this level, respectively. Preferably, the heating means are set to heat the inner space 3 to at least 195° C. (which is 75% of the melting temperature) or to maintain the temperature at this level., respectively, At the same time, the heating means are set to heat the inner space 3 to a maximum of 273° C. (which is 5% above the melting temperature), preferably a maximum of 267.8° C. (which is 3% above the melting temperature), and even more preferably a maximum of 260° C. (which is the melting temperature), or to maintain the temperature in the inner space 3 at this level, respectively.

High-Density Polyethylene (HDPE or PE-HD) has a typical melting temperature of 135° C. To configure the annealing module for HDPE, the heating means are set to heat the inner space 3 to at least 94.5° C., which is 70% of the melting temperature of 135° C., or to maintain the temperature in the inner space 3 at this level, respectively. Preferably, the heating means are set to heat the inner space 3 to at least 101.25° C. (which is 75% of the melting temperature) or to maintain the temperature at this level, respectively. At the same time, the heating means are set to heat the inner space 3 to a maximum of 141.75° C. (which is 5% above the melting temperature), preferably a maximum of 139.05° C. (which is 3% above the melting temperature), and even more preferably a maximum of 135° C. (which is the melting temperature), or to maintain the temperature in the inner space 3 at this level, respectively.

Linear Low-Density Polyethylene (LLDPE or PE-LLD) has a typical melting temperature of 110° C. To configure the annealing module for LLDPE, the heating means are set to heat the inner space 3 to at least 77° C., which is 70% of the melting temperature of 110°C., or to maintain the temperature in the inner space 3 at this level, respectively. Preferably, the heating means are set to heat the inner space 3 to at least 82.5° C. (which is 75% of the melting temperature) or to maintain the temperature at this level, respectively. At the same time, the heating means are set to heat the inner space 3 to a maximum of 115.5° C. (which is 5% above the melting temperature), preferably a maximum of 113.3° C. (which is 3% above the melting temperature), and even more preferably a maximum of 110° C. (which is the melting temperature), or to maintain the temperature in the inner space 3 at this level, respectively.

In the illustrated embodiment, the annealing module 1 is configured such that the atmosphere in the inner space 3 is an air atmosphere, and the hot gas stream 15 supplied to the inner space 3 is hot air. Furthermore, the pressure in the inner space 3 is substantially the same as the pressure in the atmosphere surrounding the annealing module 1. The use of an air atmosphere and ambient pressure in the inner space 3 is preferred simply because it means that the inner space 3 does not need to be sealed from the environment, and in particular the inlet 4 and the outlet 5 do not need to be gas-tight.

The annealing module 1 is equipped with two rotationally driven cooling rollers 12, 13 downstream of the outlet 5 of the housing 2—viewed in the direction of transport T of the plastic tapes 20—which cool the plastic tapes 20 to a temperature which allows their immediate further processing, e.g., winding onto spools.

The annealing module 1 is controlled by an electronic control module 16, which directly or indirectly controls the temperature in the inner space 3, the heating temperature of the heating means, in particular the temperature of the hot gas stream 15, and the rotational speeds of the rollers 6-13.

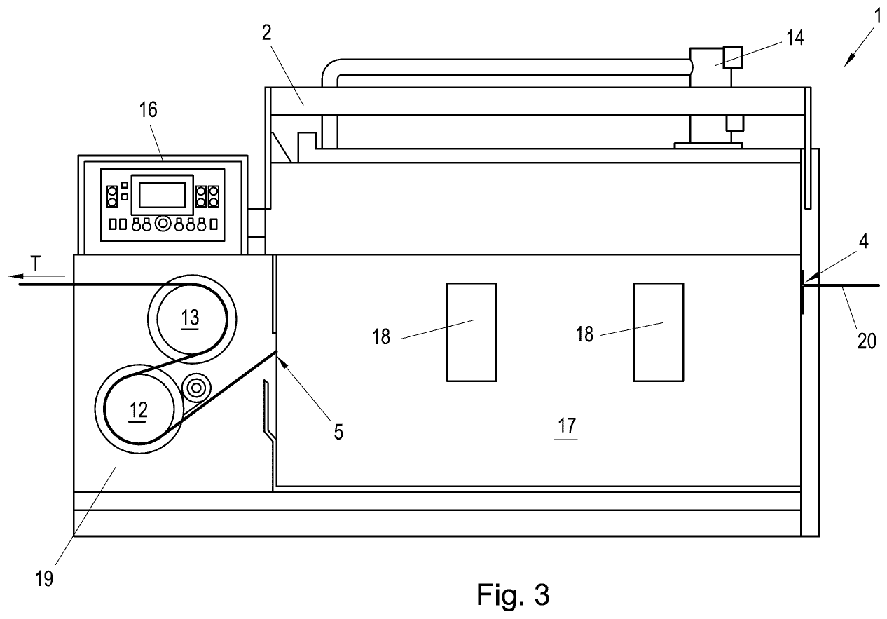

FIG. 3 shows the annealing module 1 in a closed state, with the housing door 17 folded down to seal the inner space 3. The housing door 17 is equipped with inspection windows 18, through which the operating personnel can monitor the correct path of the plastic tapes 20. Furthermore, the housing door has a transparent cover 19 made of glass or plastic, which allows a view onto the cooling rollers 12, 13, but prevents access to the cooling rollers for safety reasons.

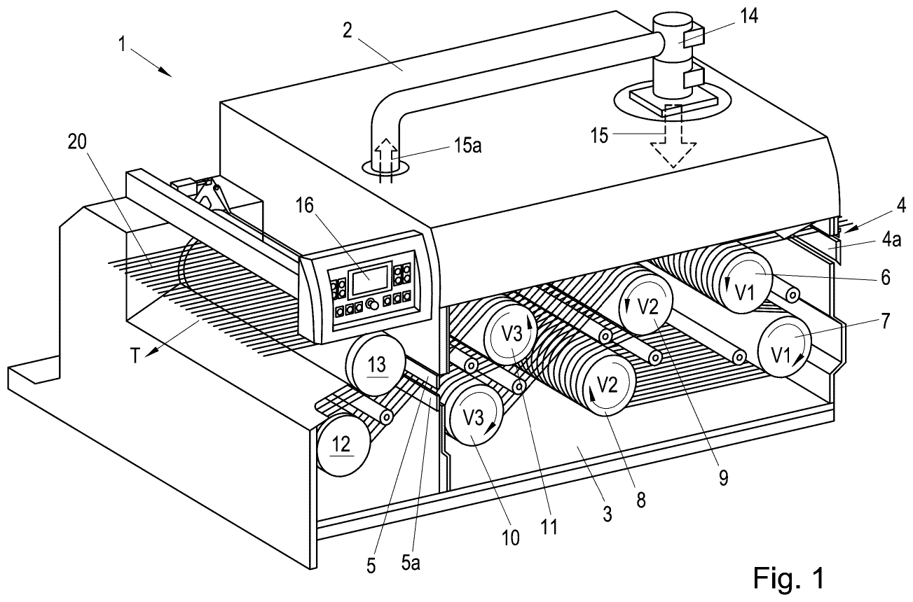

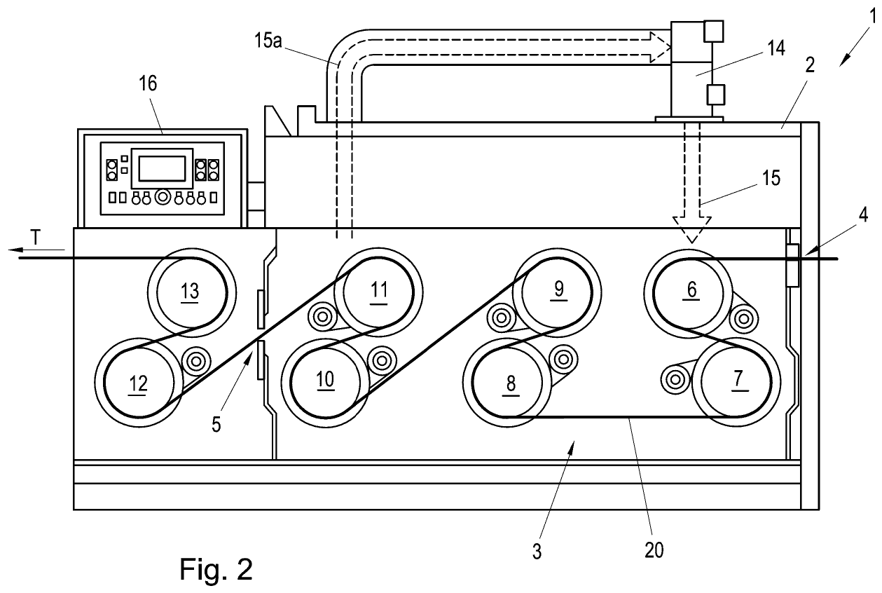

In FIGS. 1 and 2, the annealing module is shown in an open state. For reasons of clarity, the housing door 17 has been omitted in these illustrations.

### LIST OF NUMERALS

1 annealing module
2 housing
3 inner space
4 inlet
4a inlet sealing lip
5 outlet
5a outlet sealing lip
6, 7, 8, 9, 10, 11 rotationally driven rollers
12, 13 cooling rollers
14 hot gas blower
15 hot gas stream
15a return stream
16 control module
17 housing door
18 inspection window
19 transparent cover
20 plastic tape
T direction of transport of the plastic tapes
V1 circumferential speed of the first group of rollers
V2 circumferential speed of the second group of rollers
V3 circumferential speed of the third group of rollers

1-14. (canceled)

15. An annealing module, of a device for producing stretched thermoplastic tapes, the annealing module having a housing and defining an inner space, wherein the housing has an inlet and an outlet for the passage of thermoplastic tapes to be treated through the inner space, wherein, within the inner space, a plurality of rotationally driven rollers are arranged on axes parallel to each other and are configured to be at least partially enclosed by the thermoplastic tapes, wherein the annealing module is equipped with a heating source usable to heat the inner space uniformly up to a temperature, which is at least 70% of the melting temperature of the thermoplastic tapes to be treated, and the annealing module is configured to drive the rollers at such a rotational speed that the tapes, as a function of a path through the annealing module, have a dwell time within the annealing module of no more than 10 seconds.

16. The annealing module according to claim 15, wherein the heating source is configured to heat the inner space uniformly up to a temperature of no more than 5% above the melting temperature of the thermoplastic tapes to be treated.

17. The annealing module according to claim 15, wherein the housing is thermally insulated.

18. The annealing module according to claim 15, wherein the heating source comprises a hot gas stream introduced into the inner space, wherein the hot gas stream is generated by a hot gas blower arranged outside the housing, an outlet of which housing is in communication with the inner space.

19. The annealing module according to claim 18, wherein the hot gas stream is a recirculating stream, in that the hot gas stream is supplied to the inner space and is extracted as a return stream at another point of the inner space and returned to an inlet of the hot gas blower.

20. The annealing module according to claim 15, wherein the heating source comprises electric or inductive heating elements arranged in the inner space of the housing, or the heat source comprises heating elements with a heating fluid flowing through them.

21. The annealing module according to claim 15, wherein the rollers comprise heating elements, wherein the heating elements comprise electric or inductive heating elements, or heating elements with heating fluid flowing through them.

22. The annealing module according to claim 15, wherein the rotationally driven rollers are arranged so that respective shell surfaces of the rollers are wrapped around by the thermoplastic tapes at a wrap angle of less than 360°.

23. The annealing module according to claim 15, wherein some of the rotationally driven rollers are combined to form at least two roller groups, wherein the rollers of a respective roller group each have the same circumferential speeds of their respective shell surfaces, and wherein, when viewed in a direction of transport of the thermoplastic tapes, each roller group has a lower circumferential speed of the shell surfaces of the rollers than the roller group adjacent to it in an opposite direction to the direction of transport.

24. The annealing module according to claim 15, wherein one rotationally driven cooling roller, when viewed in a direction of transport of the thermoplastic tapes, is arranged downwards from the outlet of the housing.

25. The annealing module according to claim 15, wherein a control module is provided that is configured to set and control the rotational speed of the rollers and to control a further parameter that comprises one of an inner temperature and/or a heating temperature of the heating source.

26. The annealing module according to claim 15, wherein an atmosphere in the inner space is an air atmosphere and any hot gas introduced into the inner space is hot air.

27. The annealing module according to claim 15, wherein a same pressure prevails in the inner space as in an atmosphere surrounding the annealing module.

28. The annealing module according to claim 15, wherein the annealing module is usable for treatment of thermoplastic tapes made of a polyester material.
